(19) United States
(12) Patent Application Publication
(10) Pub. No.: US 2013/0233902 A1
(43) Pub. Date: Sep. 12, 2013

(54) DUAL CAMERA STRAP

(71) Applicants: Ronald Dean Henry, Seattle, WA (US); Kurt Kevin Peterson, Lynnwood, WA (US); Nancy S. Riemer, Seattle, WA (US)

(72) Inventors: Ronald Dean Henry, Seattle, WA (US); Kurt Kevin Peterson, Lynnwood, WA (US); Nancy S. Riemer, Seattle, WA (US)

(21) Appl. No.: 13/415,547

(22) Filed: Mar. 8, 2012

(51) Int. Cl. A45F 3/14; A45F 3/12; A45F 5/00; G03B 17/56

(52) U.S. Cl. 224/600; 224/264; 224/258; 224/255; 224/257

(57) ABSTRACT

An enhanced camera transport system includes a primary strap and a selectively removable secondary strap which allows a user to comfortably carry and transport two cameras simultaneously. The straps each comprise couplers that are configured to engage with an attachment point on a camera otherwise reserved by engagement with a camera stand such as a tripod, monopod, or the like. Following general camera construction, the attachment points are found on the bottom of the cameras. In some embodiments, the couplers are slidably attached to the straps to assist with repositioning of the cameras from a transport position to a picture taking position.

### FIELD OF THE INVENTION

Embodiments of the present invention relate generally to camera equipment, and more particularly, to straps for carrying camera equipment.

### BACKGROUND

Conventional straps help users store and transport various objects when not in use. Such objects may include cameras, camera bags, video recording devices, laptop bags, purses, and the like. Typically, a user will position a strap over one of his shoulders such that the object rests comfortably by his side. Conventional camera storage and carrying systems help to store and transport cameras when not in use. Unfortunately, they include aspects that can hinder retrieval of a camera being stored or transported so that photographic opportunities can be missed.

### BRIEF DESCRIPTION OF THE DRAWINGS

FIG. 1 is a front view of an embodiment of a camera transport system, shown with a primary camera and a secondary camera in resting positions and a primary strap being worn diagonally across the torso of a user.

FIG. 2 is a rear view of the system shown in FIG. 1.

FIG. 3 is a front view of the system depicted in FIG. 1, shown with the primary camera in a shooting position.

FIG. 4 is a front view of the system depicted in FIG. 1, shown with the secondary camera in a shooting position.

FIG. 5 is a perspective view of an assembly of an embodiment of a coupler secured to the primary camera, and further showing the primary strap routed through the coupler.

FIG. 6 is a front view the camera transport system shown in FIG. 1 shown removed from the user.

FIG. 7 is a rear view of the camera transport system shown in FIG. 1 shown removed from the user.

FIG. 8 is a front view of a second embodiment of a camera transport system, shown with a primary camera and a secondary camera in resting positions and a primary strap being worn diagonally across the torso of a user.

FIG. 9 is a rear view of the camera transport system shown in FIG. 8.

FIG. 10 is a front view of a third embodiment of a camera transport system, shown with a primary camera and a secondary camera in resting positions and a primary strap being worn diagonally across the torso of a user.

FIG. 11 is a rear view of the camera transport system shown in FIG. 10.

FIG. 12 is a front view of the system depicted in FIG. 1, shown with a strap bag releasably attached to the primary strap.

FIG. 13 illustrates a rear view of the strap bag shown in FIG. 12 after a first installation step wherein a top flap and a bottom flap of an attachment portion are in an open position and a coupler is attached to a loop portion of the attachment portion.

FIG. 14 illustrates a rear view of the strap bag shown in FIG. 12 after a second installation step wherein the top flap is in the open position and the bottom flap is in a closed position.

FIG. 15 illustrates a rear view of the strap bag shown in FIG. 12 after a final installation step wherein the top flap and the bottom flap are both in the closed position.

### DETAILED DESCRIPTION

Embodiments of the present invention are directed to camera transport systems that permit users to easily carry and transport two cameras simultaneously. Often, photographers carry two cameras with them for a variety of reasons, including the need for cameras with different types of lenses, the need for a backup camera in case of malfunction or damage to a primary camera, etc. However, carrying two cameras simultaneously can be difficult and tiresome due to the weight of the cameras, tangling of multiple camera straps, multiple cameras swinging during user movement, and the like. Embodiments of the present invention solve one or more of these and other issues and provide a comfortable and convenient system for allowing users to carry two cameras or two pieces of camera equipment simultaneously.

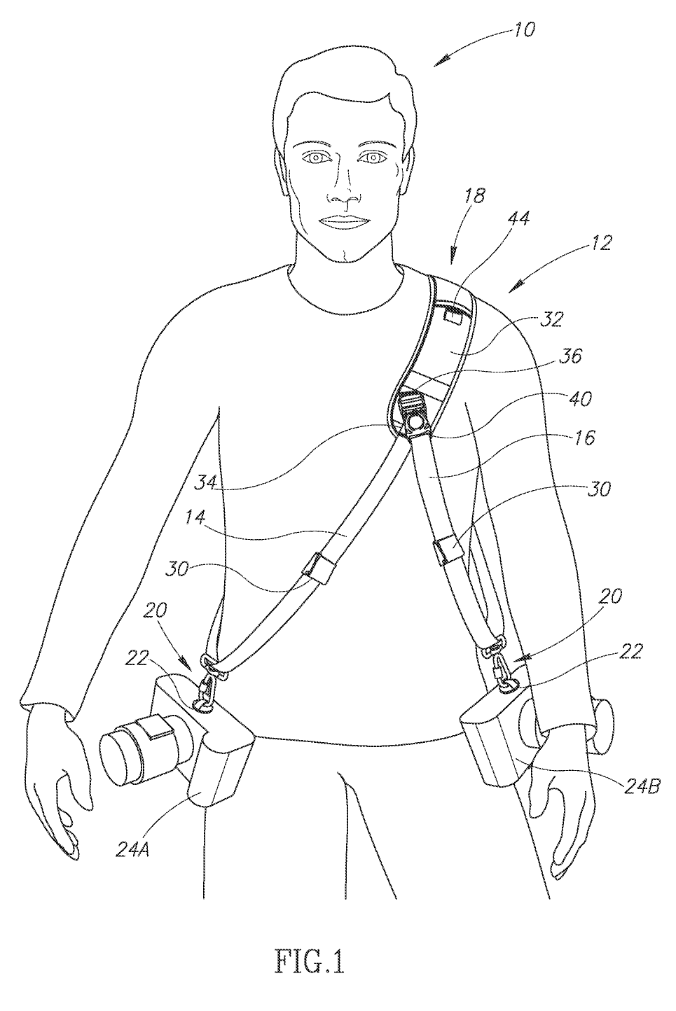

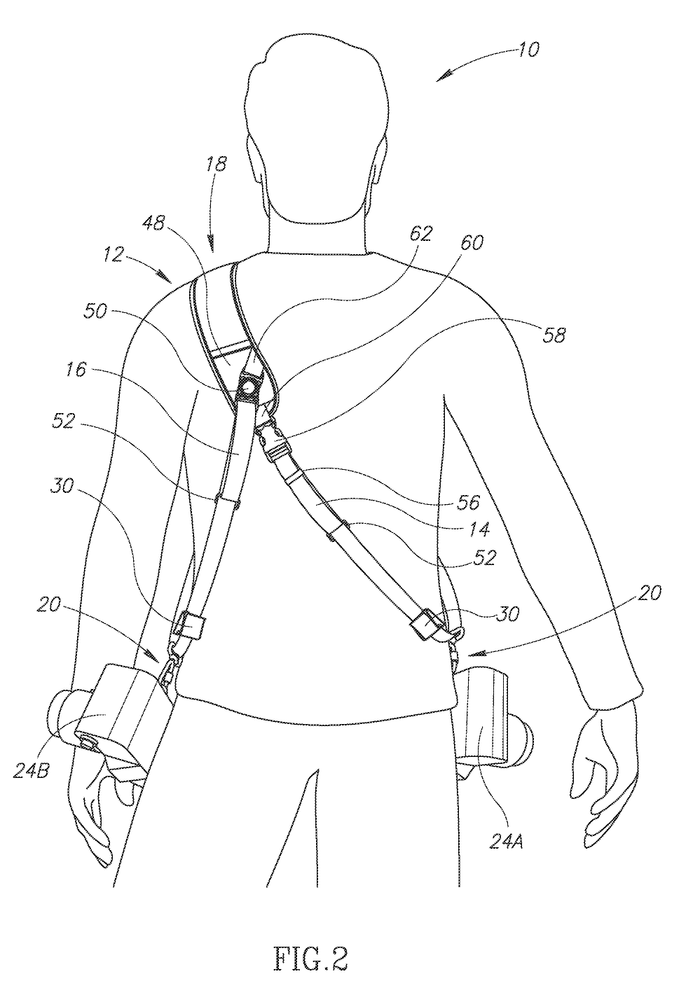

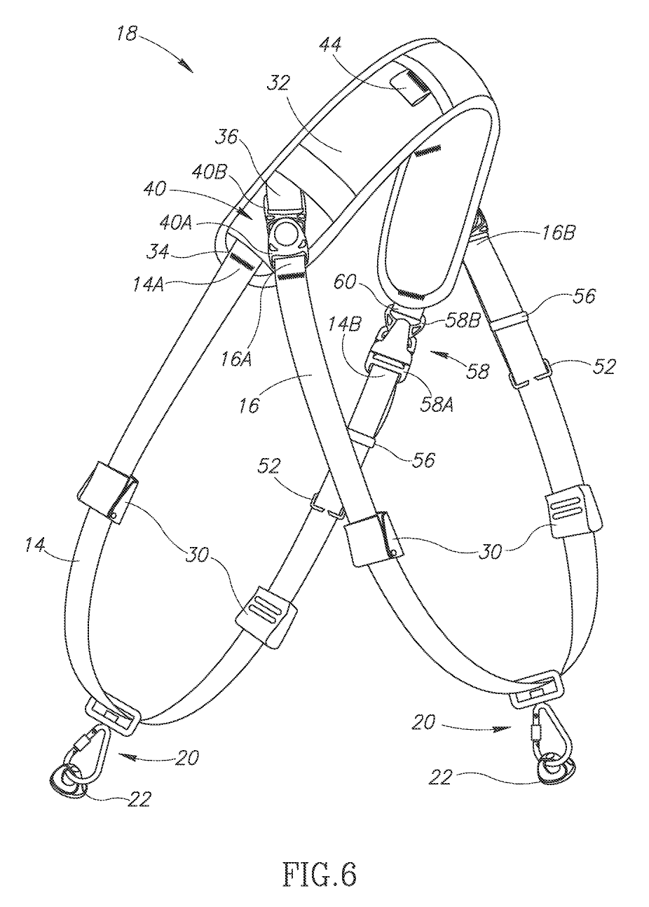

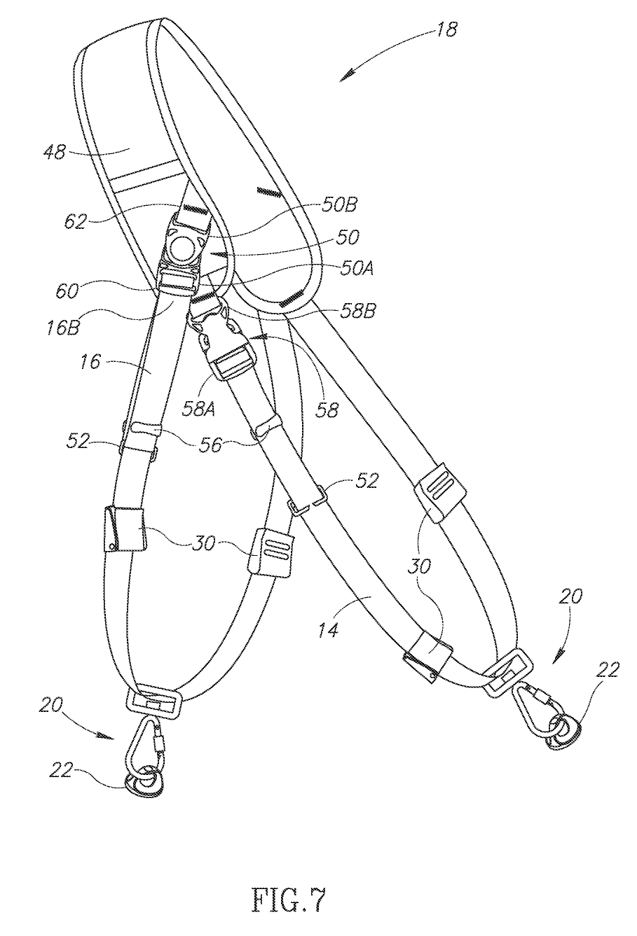

Referring to FIGS. 1 and 2, an enhanced camera transport system 12 includes a first or primary strap 14, a selectively removable second or secondary strap 16, primary and secondary couplers 20, and a shoulder pad 18 coupled to the primary and secondary straps. The primary strap 14 is worn by a user 10, typically with the shoulder pad 18 over the user's shoulder. FIGS. 6 and 7 illustrate front and rear views, respectively, of the camera transport system 12 when removed from the user 10.

The primary and secondary couplers 20 are configured to engage with an attachment point on respective primary and secondary cameras 24A and 24B otherwise reserved for engagement with a camera stand such as a tripod, monopod, or the like. Following general camera construction, the attachment point is found on the bottom of the cameras 24A and 24B or on the camera's lens. In some embodiments, the couplers 20 are slidably attached to the straps 14 and 16 to assist with repositioning of the cameras 24A and 24B from a transport position to a picture taking or “shooting” position by sliding the cameras along the straps. Other embodiments include utilizing the couplers 20 to engage one more enclosures for storage of the cameras 24A and 24B, rather than the cameras themselves.

The straps 14 and 16 can be used for retention, support, and/or suspension of the couplers 20 and cameras 24A and 24B, respectively. The front portion 32 of the shoulder pad 18 includes an accessory loop 44 configured to facilitate selective coupling of one or more accessories (not shown) that the user 10 may wish to transport. In some embodiments, holders, receptacles, pouches, or other containers can be integrated within or coupled with the straps 14 and 16 or shoulder pad 18 to store items, such as a phone, flashlight, memory, film, batteries, keys, business cards, or other items.

As shown in FIGS. 1 and 2, the primary strap 14 can be worn, by the user 10, diagonally across the torso. When used, the secondary strap 16 can extend from the shoulder pad 18 downward on the side of the user 10 on which the shoulder pad 18 is positioned. The straps 14 and 16 can further include a variety of adjusters for adjusting their length, tension, and fit. Further included can be a variety of release mechanisms and fasteners. As depicted in FIGS. 1-2 and 6-7, the straps 14 and 16 each include a plurality of camera movement limiting devices in the form of cam buckles 30 configured to limit the movement of the couplers 20 on the straps. This allows the user 10 to selectively restrict the positioning of the cameras 24A and 24B relative to the straps 14 and 16, respectively. Further, the straps 14 and 16 also include slotted loops 52 for adjusting the length of the straps, and slip rings 56 (e.g., Quick-Slip Keepers® available from DURAFLEX®) that allow for securing loose lengths of the straps.

The cameras 24A and 24B may be one or more of slidably, rotatably, pivotally, and releasably coupled to the strap 14 and 16, respectively, via the couplers 20. The cameras 24A and 24B can rest near the lower end portions of the respective straps 14 and 16 in various positions as desired by the user, when not in use. Such resting positions for the cameras 24A and 24B can include hanging topside-down.

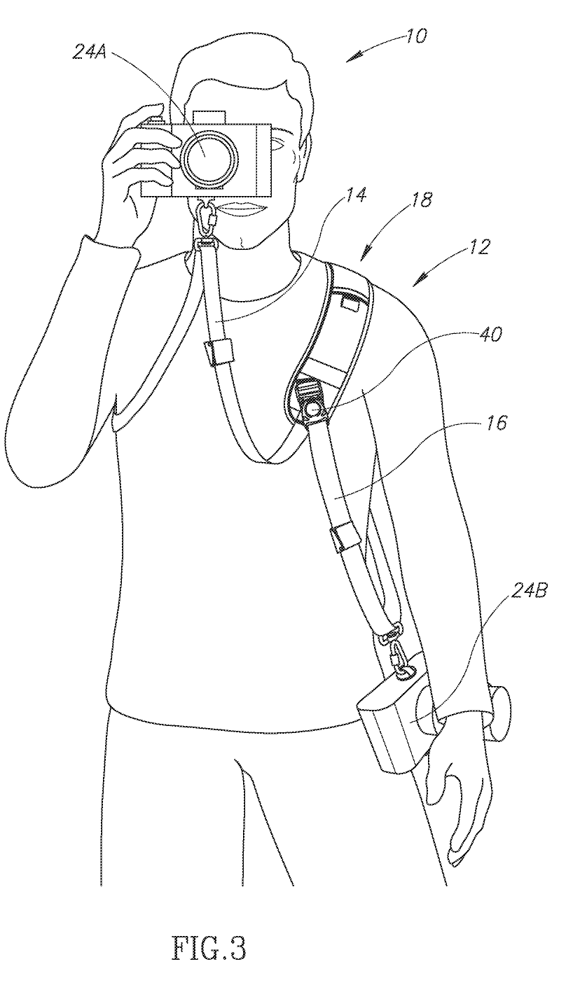

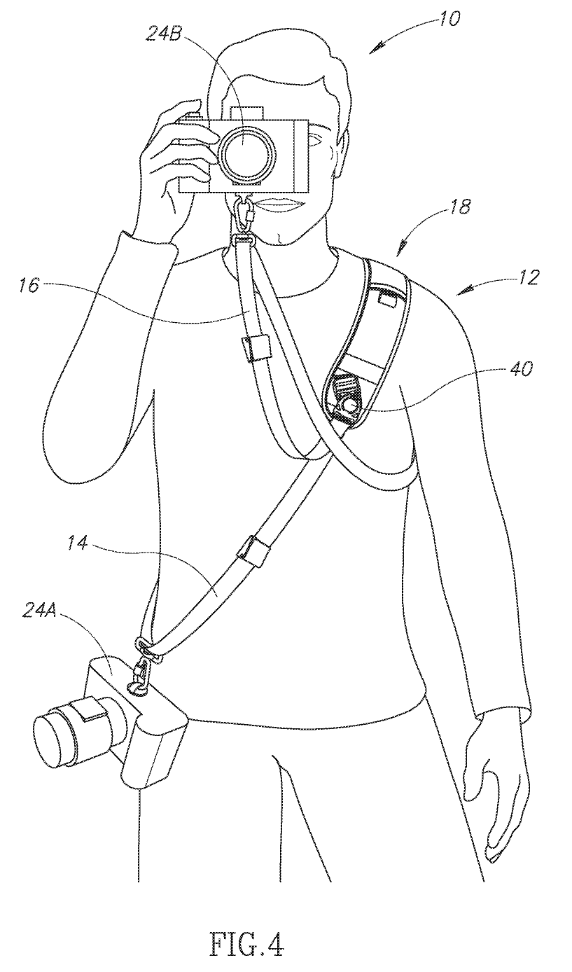

The camera transport system 12 is depicted in FIG. 3 with the primary camera 24A topside-up in a shooting position and being held by the user 10 for facilitating use of the camera to take a picture. Similarly, the system 12 is depicted in FIG. 4 with the secondary camera 24B topside-up in a shooting position and being held by the user 10 for facilitating use of the camera to take a picture. As shown, the user 10 can conveniently grasp either of the cameras 24A and 24B and raise them into shooting position to take a photo.

In some embodiments, the straps 14 and 16 have a flat sectional profile as shown and in other embodiments, the straps can have other sectional profiles such as including oblong and round profiles. Any suitable material may be used to form the straps 14 and 16. One suitable material is nylon webbing.

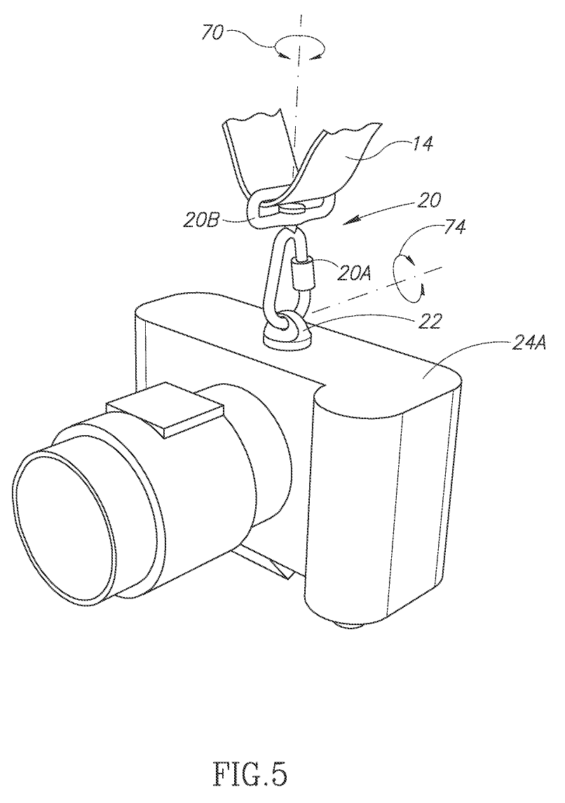

FIG. 5 illustrates an enlarged view of the coupler 20 attached to the primary camera 24A. It will be appreciated that the coupler 20 attached to the secondary camera 24B may be substantially identical or of a different design. The coupler 20 can include a fastener portion 22 that has a threadable element that engages with a conventional threadable stand socket (such for a tripod or a monopod) of a camera or lens. The coupler 20 can also include a strap engagement portion 20B in the form of a loop that slidably engages with the strap 14 and allows the camera 24A to be moved along the length of the strap, from a resting or transport location (see FIG. 1) to a shooting position (see FIG. 3) and back again into the resting location. The coupler 20 can also include a latch portion 20A to allow for quick engagement and disengagement with the fastener portion of the coupler 20 and hence allow separation of the camera 24A from the strap 14 worn by the user. In some embodiments, the latch portion 20A is of the clip or hook type or carabineer type, and has a gate style mechanism to permit connecting and disconnecting of it from a loop portion of the fastener portion 22 of the coupler 20, which facilitates removal of the camera 24A from the user 10 without removing the strap 14 from the user. The coupler 20 has the latch portion 20A pivotally coupled to the strap engagement portion 20B for rotation about a rotational axes 70 and 74 to promote proper placement of the camera on the user 10, as well as prevention of binding or tangling of the strap 14.

As shown best in FIGS. 6-7, a front end portion 14A of the primary strap 14 is fixedly attached (e.g., via stitching) to a front portion 32 of the shoulder pad 18 at a front primary strap attachment end portion 34. A back end portion 14B of the primary strap 14 is coupled to a first coupling or mating component 58A of a side release buckle 58. A second mating component 58B of the buckle 58 is coupled to a rear primary strap attachment end loop 60. Using the buckle 58, the user 10 can selectively detach the back end portion 14B of the primary strap 14 from the shoulder pad 18 as desired.

To facilitate coupling of the secondary strap 16, a front end portion 16A of the secondary strap 16 is attached to a first mating component 40A of a front swivel buckle 40 operative to rotatably and releasably couple with a second mating component 40B of the front swivel buckle that is fixedly attached to the front portion 32 of the shoulder pad 18 via a front secondary strap attachment loop 36. The back end portion 16B of the secondary strap 16 is attached to a first mating component 50A of a rear swivel buckle 50 operative to rotatably and releasably couple with a second mating component 50B of the rear swivel buckle that is fixedly attached to the rear portion 48 of the shoulder pad 18 via a rear secondary strap attachment loop 62. Thus, the secondary strap 16 can be selectively attached to the shoulder pad 18 by connecting the first and second mating components 40A and 40B of the front swivel buckle 40 together, and connecting the first and second mating components 50A and 50B of the rear swivel buckle 50 together. In some embodiments, the front swivel buckle 40 and the rear swivel buckle 50 are identical such that either the front end portion 16A or the back end portion 16B of the secondary strap 16 may be coupled to either the front portion 32 or the rear portion 48 of the shoulder pad 18. One type of suitable swivel buckle is the Swivi Lockster® made by DURAFLEX®, which allows its mating components to swivel approximately 120 degrees relative to each other (see buckle 40 shown in FIG. 4), and provides for ease of use when engaging and disengaging the buckle.

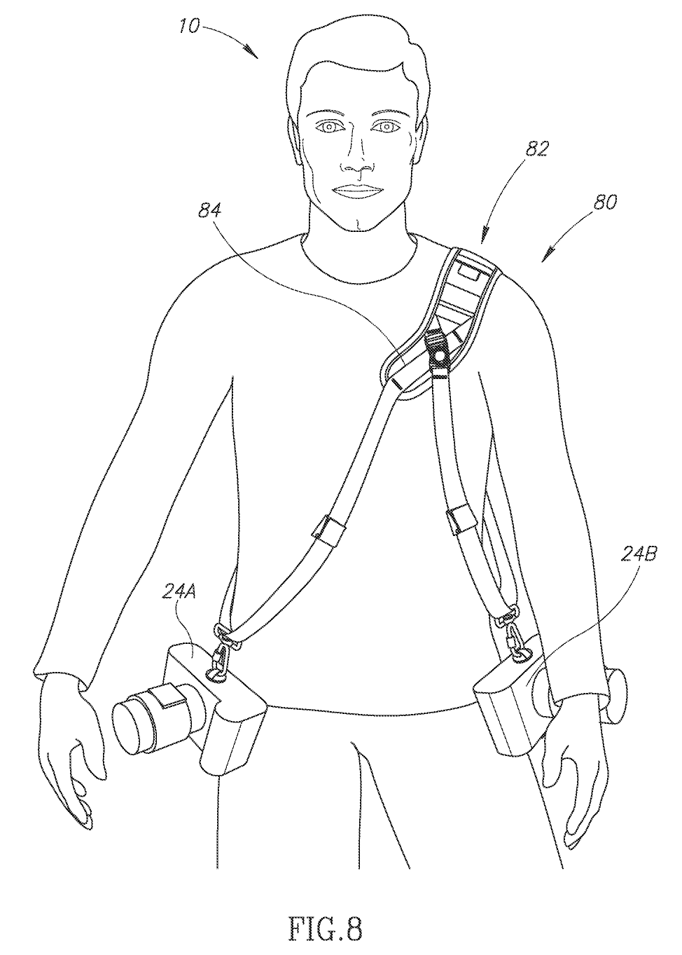

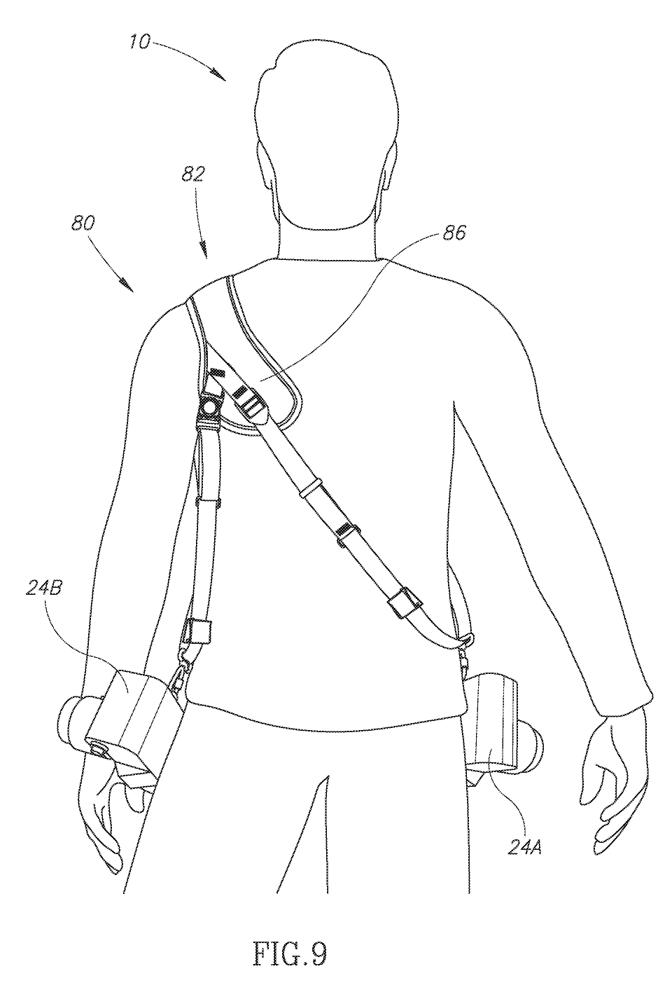

FIGS. 8 and 9 illustrate front and back views, respectively, of a second embodiment of a camera transport system 80. The system 80 is similar to the system 12 described above in many respects, so only the differences in this embodiment are described herein. The camera transport system 80 comprises a “sport” shaped shoulder pad 82 having a front portion 84 that is slanted toward the opposite side of the torso of the user 10 when worn by the user. The shoulder pad 82 also includes a rear portion 86 that is substantially wider than the rest of the shoulder pad 82.

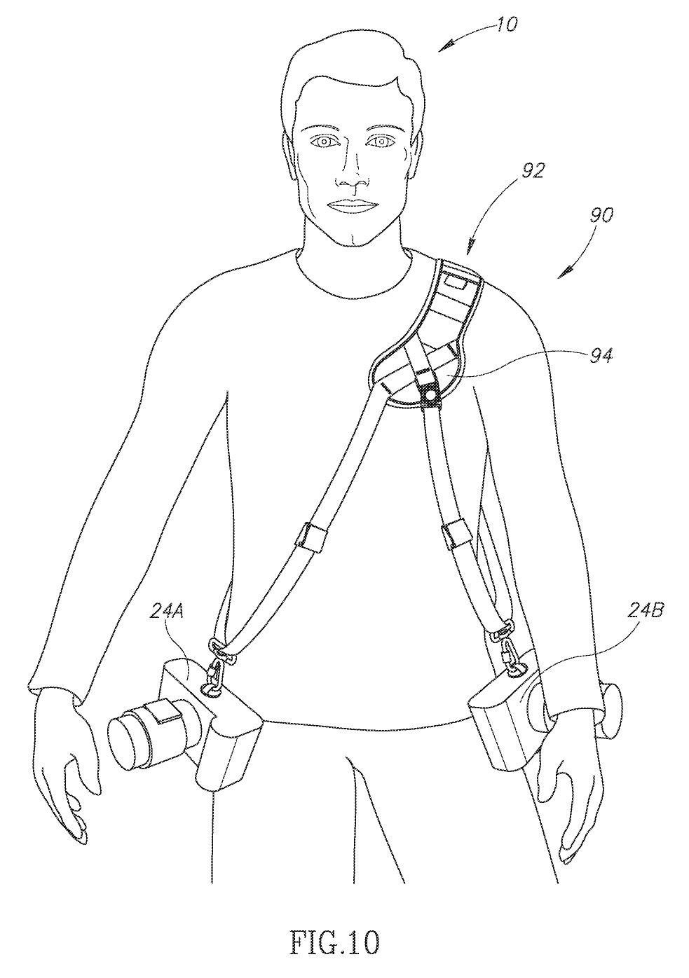

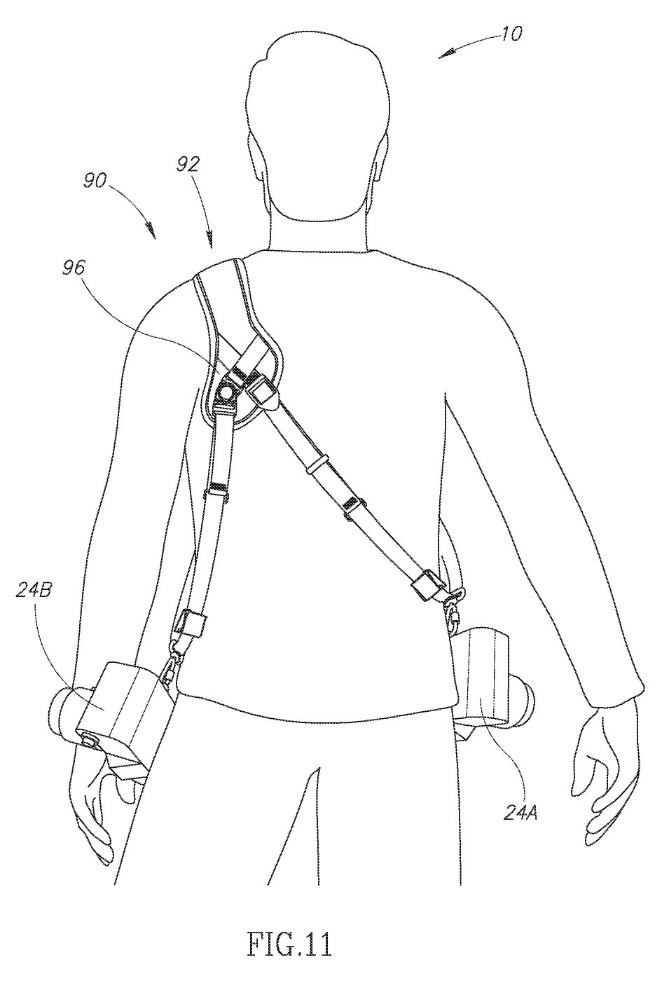

FIGS. 10 and 11 illustrate front and back views, respectively, of a third embodiment of a camera transport system 90. The system 90 is similar to the systems 12 and 80 described above, except the system 90 includes a shoulder pad 92 having an enlarged front portion 94 and an enlarged rear portion 96.

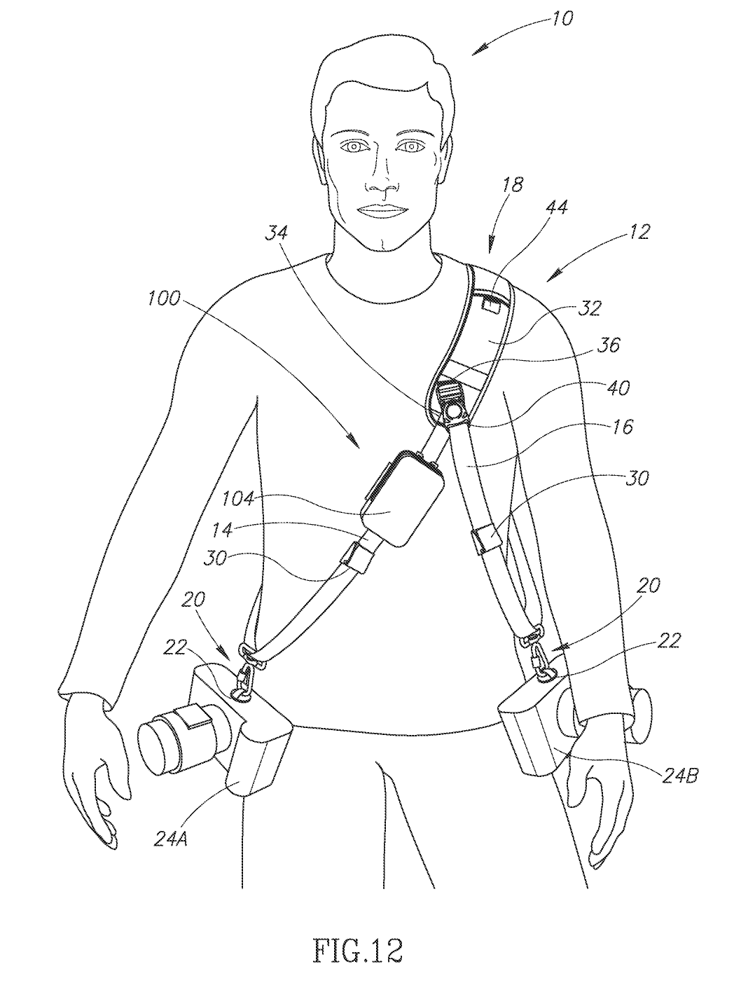

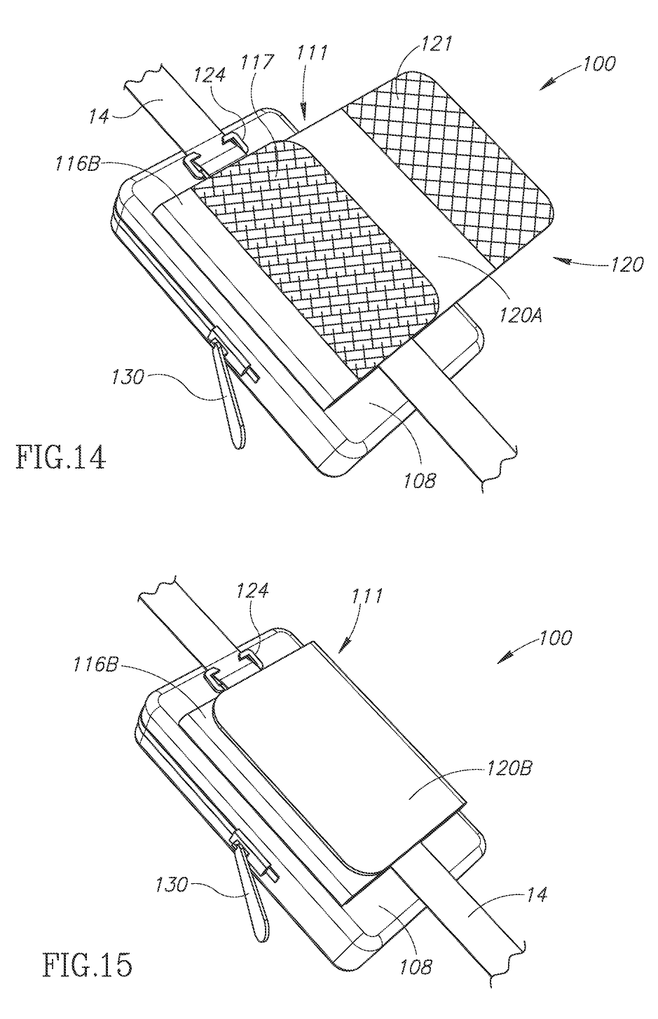

FIG. 12 illustrates a strap bag 100 that may be releasably attached to the strap 14 (or to the strap 16). The strap bag 100 may be various shapes and sizes as desired, and may be used to carry camera accessories, phones, wallets, keys, and the like. As shown in FIG. 14, the strap bag 100 comprises a zipper 130 for allowing a user to selectively open and close the bag.

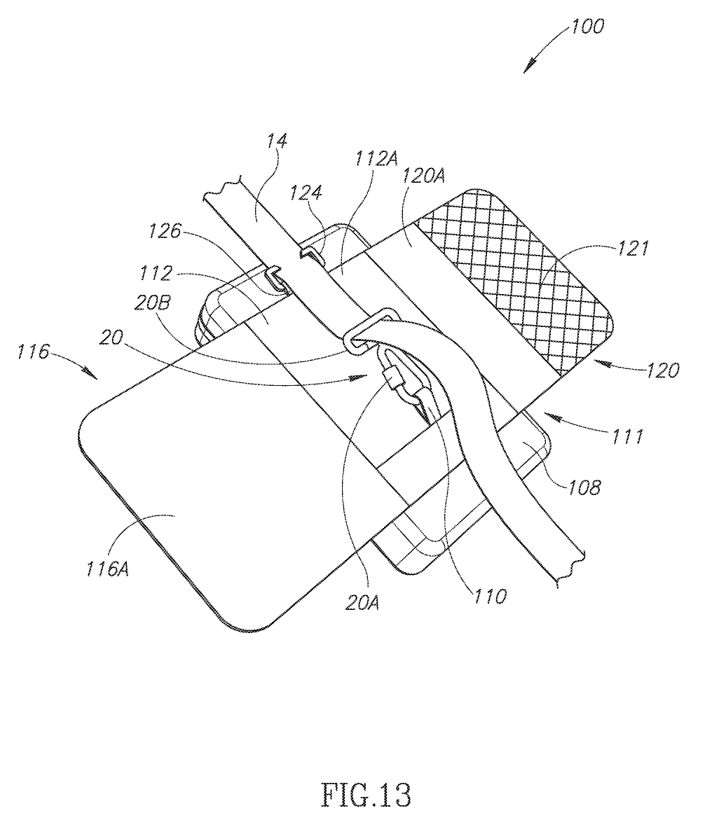

FIGS. 13-15 illustrate a progression of steps for attaching the strap bag 100 to the strap 14. The strap bag 100 includes an outwardly facing front portion 104 (see FIG. 12) disposed opposite an inwardly facing rear portion 108 (see FIG. 13). An attachment portion 111 is fixedly coupled (e.g., sewn) to the rear portion 108 of the strap bag 100. The attachment portion 111 includes a center portion or body 112, a top flap 120, and a bottom flap 116. The top flap 120 includes an inside surface 120A and an outside surface 120B. Similarly, the bottom flap 116 includes an inside surface 116A and an outside surface 1168. The width of the center body 112 is configured to be larger than width of the strap 14 so that the strap may be sandwiched between the center body 112 on one side and the bottom and top flaps 116 and 120 on the other side. In the embodiment shown, the width of the center body 112 is substantially the same as the width of the rear portion 108 of the strap bag 100.

As shown in FIG. 13, the inside surface 120A of the top flap 120 includes a hook tape piece 121. As shown in FIG. 14, the outside surface 1168 of the bottom flap 116 includes a corresponding loop tape piece 117 positioned to releasably engage the hook tape piece 121 when the flaps 116 and 120 are folded from the open position (shown in FIG. 13) into the closed position (shown in FIG. 15). The hook tape piece 121 and the loop tape piece 117 may be coupled to the top flap 120 and the bottom flap 116, respectively, by any suitable manner (e.g., sewn together). It will be appreciated that, in addition to such Velcro® type fasteners, other types of fasteners may be used to selectively releasably attach the top flap 120 and the bottom flap 116 together, including snaps, buttons, magnets, and the like.

As shown in FIG. 13, the center body 111 of the attachment portion 110 also comprises a loop portion 110 configured to selectively couple with a coupler 20. The coupler 20 includes a strap engagement portion 20B in the form of a loop that slidably engages with the strap 14. The coupler 20 also includes a latch portion 20A to allow for quick engagement and disengagement with the loop portion 110 and hence to allow separation of the strap bag 100 from the strap 14 worn by the user.

An upper end portion 112A of the center body 112 includes a c-shaped slotted loop 124 that is secured to the center body by small flap portion 126 stitched to the center body (see FIG. 13). The slotted loop 124 is configured to receive and engage the strap 14 to help prevent the strap bag 100 from sliding along or otherwise moving relative to the strap during use.

During use, a user may first connect the coupler 20 (which is coupled to the strap 14) to the loop portion 110 of the attachment portion and thread the strap 14 through the c-shaped slotted loop 124, when the top flap 120 and the bottom flap 116 of the attachment portion 111 are in the open position, so that the strap bag 100 is securely attached to the strap. This step is shown in FIG. 13. As shown in FIG. 14, the user may then fold the bottom flap 116 over the strap 114 such that the inside surface 116A of the bottom flap 116 is adjacent the strap and the outside surface 116B is facing outward. In this position, the loop tape piece 117 is also facing outward. As shown in FIG. 15, the user may then fold the top flap 120 over the outside surface 116B of the bottom flap 116 so that the hook tape piece 121 on the inside surface 120A of the top flap engages the loop tape piece 117. Thus, the strap bag 100 is secured to the strap 14 by the loop portion 110 (attached to the coupler 20), the c-shaped slotted loop 124, and the closed flaps 116 and 120. Once secured to the strap 14, the user may carry the strap bag 100 securely as shown in FIG. 12.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

We claim:

1. A camera transport system for use with first and second cameras each having an engagement portion, comprising:
a shoulder pad configured to be positioned over a first side shoulder of a user;
a first strap couplable to the shoulder pad and configured to extend diagonally downward therefrom toward a second side hip of the user opposite the first side shoulder;
a first coupler having a first portion configured to releasably engage with the engagement portion of the first camera, and a second portion configured to slidably engage with the first strap;
a second strap couplable to the shoulder pad and configured to extend downward therefrom toward a first side hip of the user opposite the second side hip; and
a second coupler having a first portion configured to releasably engage with the engagement portion of the second camera, and a second portion configured to slidably engage with the second strap.

2. The camera transport system of claim 1, wherein the second strap is releasably couplable to the shoulder pad by at least one strap coupler having a first coupling component attached to the shoulder pad and a second coupling component attached to the second strap.

3. The camera transport system of claim 2, wherein the second strap comprises a first end portion having the second coupling component attached thereto, and a second end portion, and the shoulder pad comprises a front portion having the first coupling component attached thereto, and a rear portion, and the second portion of the second strap is releasably couplable to the rear portion of the shoulder pad by at least one strap coupler having a third coupling component attached to the rear portion and a fourth coupling component attached to the second portion of the second strap.

4. The camera transport system of claim 2, wherein the second strap comprises a first end portion and a second end portion, one of which having the second coupling component attached thereto and the other having a third coupling component attached thereto, and the shoulder pad comprises a front portion and a rear portion, one of which having the first coupling component attached thereto and the other having a fourth coupling component attached thereto, wherein the second and third coupling components of the second strap are each releasably couplable to each of the first and fourth coupling components of the shoulder pad.

5. The camera transport system of claim 2, wherein the first and second coupling components are pivotally couplable together to swivel with respect to each other when coupled together.

6. The camera transport system of claim 1, wherein the second strap is rotatably couplable to the shoulder pad by at least one strap coupler having a first coupling component attached to the shoulder pad and a second coupling component attached to the second strap.

7. The camera transport system of claim 6, wherein the second strap comprises a first end portion having the second coupling component attached thereto, and a second end portion, and the shoulder pad comprises a front portion having the first coupling component attached thereto, and a rear portion, and the second portion of the second strap is rotatably couplable to the rear portion of the shoulder pad by at least one strap coupler having a third coupling component attached to the rear portion and a fourth coupling component attached to the second portion of the second strap.

8. The camera transport system of claim 6, wherein the second strap comprises a first end portion and a second end portion, one of which having the second coupling component attached thereto and the other having a third coupling component attached thereto, and the shoulder pad comprises a front portion and a rear portion, one of which having the first coupling component attached thereto and the other having a fourth coupling component attached thereto, wherein the second and third coupling components of the second strap are each rotatably couplable to each of the first and fourth coupling components of the shoulder pad.

9. The camera transport system of claim 1, wherein the first strap has at least one end fixedly coupled to the shoulder pad.

10. The camera transport system of claim 1, wherein the first strap has a first end portion fixedly coupled to the shoulder pad and a second end portion releasably coupled to the shoulder pad.

11. The camera transport system of claim 1, wherein the first strap has a first end portion fixedly coupled to a front portion of the shoulder pad and a second end portion releasably couplable to a rear portion of the shoulder pad.

12. The camera transport system of claim 1, wherein the second strap has a first end portion releasably couplable to a front portion of the shoulder pad and a second end portion releasably couplable to a rear portion of the shoulder pad.

13. The camera transport system of claim 1, wherein the length of the first strap is selectively adjustable.

14. The camera transport system of claim 1, wherein the length of the second strap is selectively adjustable.

15. The camera transport system of claim 1, wherein the first and second couplers are configured for threaded engagement with the engagement portions of the first and second cameras, respectively, which are tripod attachment points.

16. The camera transport system of claim 1, wherein the first strap and the second strap are constructed from nylon material.

17. The camera transport system of claim 1, further comprising a strap bag releasably couplable the either of the first strap and the second strap.

18. The camera transport system of claim 17, wherein the strap bag comprises an attachment portion having a first flap and a second flap that are selectively attachable to each other and configured to cover a portion of either of the first and second straps when the strap bag is coupled to one of the first and second straps.

19. A camera transport system for use with first and second cameras, each having an engagement portion, comprising:
a shoulder pad configured to be positioned over a first side shoulder of a user;
a first strap coupled to the shoulder pad and configured to extend diagonally downward therefrom toward a second side hip of the user opposite the first side shoulder;
a first coupler having a first portion configured to releasably engage with the engagement portion of the first camera, and a second portion configured to slidably engage with the first strap;
a second strap engagement portion fixedly coupled to the shoulder pad and configured for selective coupling with a second strap that is configured to extend downward from the shoulder pad when coupled thereto toward a first side hip of the user opposite the second side hip and comprises a second coupler having a first portion configured to releasably engage with the engagement portion of the second camera, and a second portion configured to slidably engage with the second strap.

20. The camera transport system of claim 19, wherein the second strap is releasably couplable to the shoulder pad by at least one strap coupler comprising the second strap engagement portion as a first coupling component and a second coupling component attached to the second strap.

21. The camera transport system of claim 20, wherein the second strap comprises a first end portion having the second coupling component attached thereto, and a second end portion, and the shoulder pad comprises a front portion having the first coupling component attached thereto, and a rear portion, and the second portion of the second strap is releasably couplable to the rear portion of the shoulder pad by at least one strap coupler having a third coupling component attached to the rear portion and a fourth coupling component attached to the second portion of the second strap.

22. The camera transport system of claim 20, wherein the second strap comprises a first end portion and a second end portion, one of which having the second coupling component attached thereto and the other having a third coupling component attached thereto, and the shoulder pad comprises a front portion and a rear portion, one of which having the first coupling component attached thereto and the other having a fourth coupling component attached thereto, wherein each of the second and third coupling components of the second strap are releasably couplable to each of the first and fourth coupling components of the shoulder pad.

23. The camera transport system of claim 20, wherein the first coupling component and the second coupling component are pivotally couplable together to swivel with respect to each other when coupled together.

24. The camera transport system of claim 19, wherein the second strap is rotatably couplable to the shoulder pad by at least one strap coupler comprising the second strap engagement portion as a first coupling component and a second coupling component attached to the second strap.

25. The camera transport system of claim 24, wherein the second strap comprises a first end portion having the second coupling component attached thereto, and a second end portion, and the shoulder pad comprises a front portion having the first coupling component attached thereto, and a rear portion, and the second portion of the second strap is rotatably couplable to the rear portion of the shoulder pad by at least one strap coupler having a third coupling component attached to the rear portion and a fourth coupling component attached to the second portion of the second strap.

26. The camera transport system of claim 24, wherein the second strap comprises a first end portion and a second end portion, one of which having the second coupling component attached thereto and the other having a third coupling component attached thereto, and the shoulder pad comprises a front portion and a rear portion, one of which having the first coupling component attached thereto and the other having a fourth coupling component attached thereto, wherein each of the second and third coupling components of the second strap are rotatably couplable to each of the first and fourth coupling components of the shoulder pad.

27. The camera transport system of claim 19, wherein the first strap has at least one end fixedly coupled to the shoulder pad.

28. The camera transport system of claim 19, wherein the first strap has a first end portion fixedly coupled to the shoulder pad and a second end portion releasably coupled to the shoulder pad.

29. The camera transport system of claim 19, wherein the first strap has a first end portion fixedly coupled to a front portion of the shoulder pad and a second end portion releasably couplable to a rear portion of the shoulder pad.

30. The camera transport system of claim 19, wherein the length of the first strap is selectively adjustable.

31. The camera transport system of claim 19, wherein the first coupler is configured for threaded engagement with the engagement portion of the first camera, which is a tripod attachment point.

32. The camera transport system of claim 19, wherein the first strap is constructed from nylon material.

33. A camera transport system for use with first and second cameras each having an engagement portion, comprising:
a first strap configured to be positioned over a first side shoulder of a user and to extend diagonally downward therefrom toward a second side hip of the user opposite the first side shoulder;
a first coupler having a first portion configured to releasably engage with the engagement portion of the first camera, and a second portion configured to slidably engage with the first strap;
a second strap couplable to the first strap and configured to extend downward therefrom toward a first side hip of the user opposite the second side hip; and
a second coupler having a first portion configured to releasably engage with the engagement portion of the second camera, and a second portion configured to slidably engage with the second strap.

34. The camera transport system of claim 33, wherein the first strap further comprises a shoulder pad.

35. The camera transport system of claim 33, wherein the second strap is couplable to the shoulder pad of the first strap.

36. A camera transport system, comprising:
a first strap configured to be positioned over a first shoulder of a user and to extend downward toward a first side of a user;
a first coupler having a first portion configured to releasably engage with an engagement portion of a first camera, and a second portion configured to engage with the first strap;
a second strap engagement portion coupled to the first strap and configured to selectively couple a second strap with the first strap such that the second strap extends downward toward a second side of the user different from the first side, the second strap further comprising a second coupler having a first portion configured to releasably engage with an engagement portion of a second camera, and a second portion configured to engage with the second strap.

37. The camera transport system of claim 36, wherein the first strap further comprises a shoulder pad.

38. The camera transport system of claim 37, wherein the second strap is couplable to the shoulder pad of the first strap.

39. The camera transport system of claim 37, further comprising a strap bag releasably couplable the either of the first strap and the second strap.

40. The camera transport system of claim 38, wherein the strap bag comprises an attachment portion having a first flap and a second flap that are selectively attachable to each other and configured to cover a portion of either of the first and second straps when the strap bag is coupled to one of the first and second straps.

41. The camera transport system of claim 39, wherein the strap bag comprises an attachment portion having a loop portion configured for selective attachment to a coupler that is attachable to either of the first and second straps.
